(19) United States
(12) Patent Application Publication
(10) Pub. No.: US 2022/0134625 A1
(43) Pub. Date: May 5, 2022

(54) DISTRIBUTION BLOCK

(71) Applicant: Collin Lab & Pilot Solutions GmbH, Maitenbeth (DE)

(72) Inventor: Friedrich KASTNER, Grieskirchen (AT)

(73) Assignee: Collin Lab & Pilot Solutions GmbH, Maitenbeth (DE)

(21) Appl. No.: 17/435,106

(22) PCT Filed: Mar. 19, 2020
(86) PCT No.: PCT/EP2020/057540

§ 371 Date: Aug. 31, 2021

(30) Foreign Application Priority Data
Mar. 20, 2019 (AT) A 50245/2019

(51) Int. Cl. B29C 48/495; B29C 48/25; B29C 48/255; B29C 48/92; B29C 48/08; B29C 48/21

(52) U.S. Cl. CPC B29C 48/495; B29C 48/254; B29C 48/2556; B29C 2948/92704; B29C 48/08; B29C 48/21; B29C 48/92

(57) ABSTRACT

The invention relates to a distribution block for extrusion melt and a method for coextruding films with the aid of a distribution block for extrusion melt, wherein the distribution block comprises a movable sleeve.

The invention relates to a distribution block for extrusion melt and a method for coextruding films with the aid of a distribution block for extrusion melt.

Generic distribution blocks are used, for example, in plastic material processing for coextruding plastic material and/or fluid or extrusion melt from different extruders together.

In known distribution blocks, distribution cores are used to connect channels in the distribution block and coextrude plastic material and/or fluid from different extruders together. The distribution cores, among other things, determine how the plastic material and/or fluid is coextruded from the different extruders connected to the distribution block. The distribution cores are inserted into the distribution block and connected to it. For different coextrusion, different distribution cores must be inserted manually. This has a negative impact for example on the setup time of such plants.

It was the object of the present application to overcome the shortcomings of the prior art and to provide a device and a method, by means of which a user is capable of realizing a reduction of the setup time.

This object is achieved by means of a device and a method according to the enclosed independently claims.

A device according to the present application relates to a distribution block for extrusion melt. This distribution block for extrusion melt comprises a base body and at least one sleeve. The base body and the at least one sleeve have communicating fluid channels. Moreover, the at least one sleeve is mounted in the base body so as to be movable. Moreover, the at least one sleeve may be positioned in a first position in relation to the base body, so as to bring a first group of fluid channels of the at least one sleeve in communication with fluid channels of the base body. This may be advantageous since by the movability of the at least one sleeve in relation to the base body, the at least one sleeve may be brought into the first position. In other words, advantageously, a switchable sleeve may be obtained. A sleeve within the scope of the present application is understood to be a body that is substantially rotationally symmetrical about a longitudinal axis. Fluid channels are inserted into this body, inter alia. The body and/or the sleeve may still comprise non-symmetrical sections.

According to a further aspect of the present application, in a distribution block for extrusion melt, the at least one sleeve may be positioned in a second position in relation to the base body, so as to bring a second group of fluid channels of the at least one sleeve in communication with the fluid channels of the base body. This may be advantageous since hence a different distribution of the extrusion melt in relation to the first position may be achieved. This may advantageously increase the flexibility of the device.

According to a further aspect of the present application, in a distribution block for extrusion melt, at least one fluid channel of the first group of fluid channels of the at least one sleeve may be configured to be operated at a different temperature level than a second fluid channel of the first group of fluid channels of the at least one sleeve. This may be advantageous since hence different fluids may be carried in the different fluid channels at their respective optimum temperature.

According to a further aspect of the present application, in a distribution block for extrusion melt, the fluid channels of a group of fluid channels of the at least one sleeve may be thermally insulated from one another or may be heated individually. This may be advantageous since hence different fluids are carried in the different fluid channels at different temperatures, as the individual channels do not have an impact on one another regarding their temperature.

According to a further aspect of the present invention, in a distribution block for extrusion melt, the at least one sleeve may be mounted in the base body so as to be linearly displaceable along its longitudinal axis and/or rotatable in relation to its longitudinal axis. This may be advantageous since the at least one sleeve may thus be moved in the base body efficiently and/or freely selectable.

According to a further aspect of the present application, the at least one sleeve may be movable by motor in a distribution block for extrusion melt. This may be advantageous since the at least one sleeve may thus be moved remotely and/or automatically. A motorized drive may for example be electric, hydraulic, pneumatic or any combination thereof. Latching and/or locking of the sleeve in one of the positions can be done by a separate locking device or by the motorized drive.

According to a further aspect of the present application, in a distribution block for extrusion melt, the at least one sleeve has sealing sections. This may be advantageous since hence a leakage of fluid from the at least one sleeve may be prevented.

According to a further aspect of the present application, in a distribution block for extrusion melt, the fluid channels in the at least one sleeve and the base body may be brought into a rinsing position in relation to one another by movement of the sleeve. This may be advantageous since hence a fluid present in the fluid channels may be removed or replaced by another fluid.

According to a further aspect of the present application, in a distribution block for extrusion melt, the at least one sleeve may protrude from the base body on both ends. This may be advantageous since hence many fluid channels may be provided in the at least one sleeve. Moreover, this may be advantageous since hence, for example, multiple positions of the at least one sleeve may be realized.

According to a further aspect of the present application, in a distribution block for extrusion melt, the at least one sleeve may be essentially conical. This may be advantageous since hence, for example, a sealing seat of the at least one sleeve in the base body may be improved.

According to a further aspect of the present application, a distribution block for extrusion melt according to the application may comprise multiple sleeves. This may be advantageous since hence additional extruders may be connected to the distribution block.

According to another aspect of the present application, a method for coextruding films with the aid of a distribution block for extrusion melt comprises the steps of connecting extruders to the distribution block for extrusion melt, positioning at least one sleeve in a first position, such that fluid channels in a base body of the distribution block for extrusion melt communicate with fluid channels in the at least one sleeve, a first coextrusion, adjusting the at least one sleeve to a second position in relation to the base body, such that other fluid channels communicate, and a second coextrusion. This may be advantageous since two different coextrusions may be performed with the same at least one sleeve. This may advantageously increase the efficiency of the distribution block since, for example, no other sleeve must be installed and/or the sleeve does not have to be exchanged in a time-consuming manner.

According to a further aspect of the present application, the method may moreover comprise controlling the temperature of at least one of the base body, the at least one sleeve or the fluid channels in the base body and/or the at least one sleeve. This may be advantageous since thereby a fluid may be conveyed in the distribution block, the at least one sleeve or a fluid channel at its optimum temperature.

According to a further aspect of the present application, in a method, controlling the temperature may depend on the position of the at least one sleeve. This may be advantageous since it is hence possible to use different temperatures for different coextrusions and thus increase the quality of the extrusions.

According to a further aspect of the present application, the method may comprise rinsing after the first coextrusion and prior to positioning in the second position. This may be advantageous since hence fluid from the first coextrusion may be removed from the fluid channels before the second coextrusion takes place. As a further alternative, rinsing may be carried out after positioning in the second position. Hence, the fluid of the second position may be used already during rinsing.

The aspects stated above may be combined with one another in any way and, in particular, aspects of the method for coextrusion may be translated into aspects of the distribution block and vice versa.

For the purpose of better understanding of the application, it will be elucidated in more detail by means of the figures below.

These show in a respectively very simplified schematic representation:

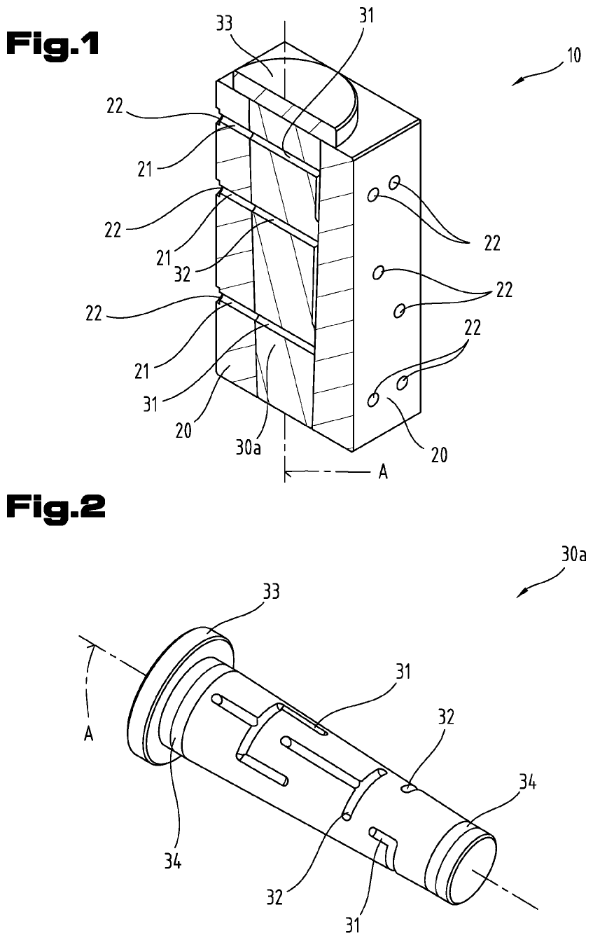

FIG. 1 a sectional view of a distribution block with a sleeve according to a first exemplary embodiment;

FIG. 2 a perspective view of a sleeve according to a first exemplary embodiment;

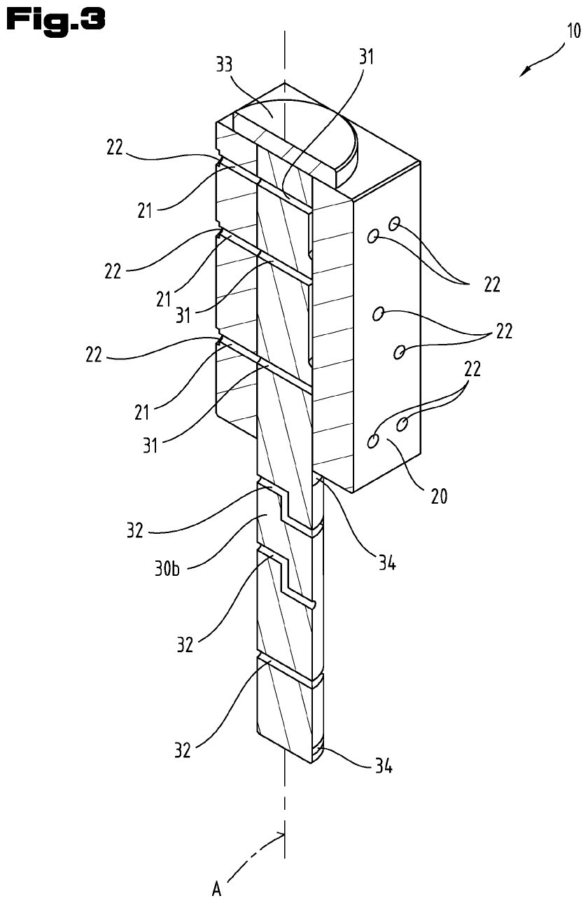

FIG. 3 a sectional view of a distribution block with a sleeve according to a second exemplary embodiment;

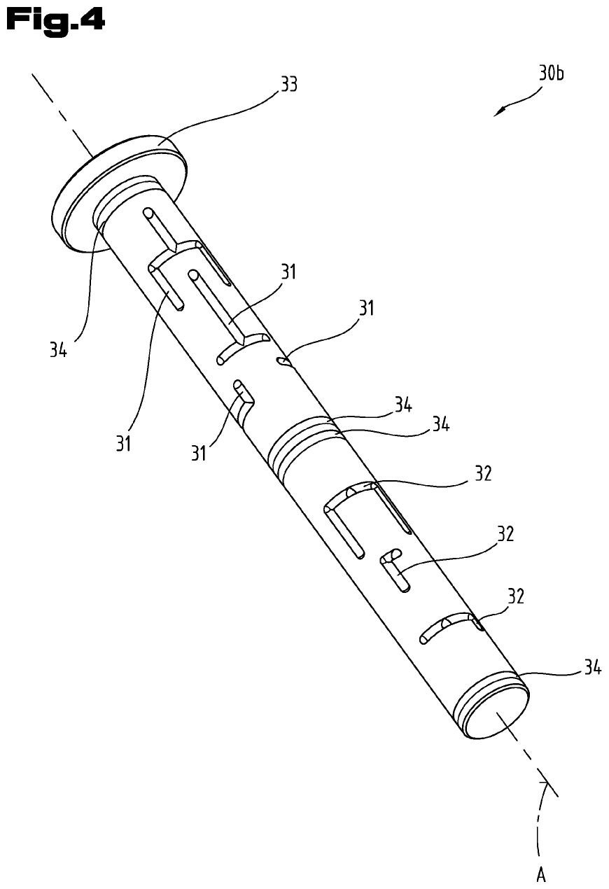

FIG. 4 a perspective view of a sleeve according to a second exemplary embodiment.

First of all, it is to be noted that in the different exemplary embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

First, reference is made to FIG. 1, wherein FIG. 1 discloses a distribution block 10 for extrusion melt. The distribution block 10 comprises a base body 20 into which a sleeve 30a is inserted. Base body ports 22 at the outer sides of the base body 20 are connected with the base body fluid channels 21 in the base body 20 and reach to the receiving opening into which the sleeve 30a is inserted. Extruders and/or tools (for example film tools) may be connected to the base body ports 22.

As can be seen in FIG. 2, the sleeve 30a is an essentially conically tapering body, which is essentially rotationally symmetrical along its longitudinal axis A. The sleeve 30a comprises a flange 33 via which the sleeve 30a may be rotated about its longitudinal axis A in the base body 20. The sleeve 30a tapers from the flange 33 along the longitudinal axis A and is thus essentially conical. The sleeve 30a may also be cylindrical and thus the receiving opening in the base body 20 as well. The sleeve 30a is shown being flush with the base body 20 at the bottom in FIG. 1. The sleeve 30a may also protrude from the base body 20 at the bottom.

The sleeve 30a comprises first fluid channels 31 and second fluid channels 32, as well as sealing sections 34. The sealing sections 34 prevent a leakage of fluid along the longitudinal axis A in both directions. The first and second fluid channels 31 and 32 of the sleeve 30a are provided for connecting and/or bringing into communication the base body ports 22 shown on the left and right side of the base body 20 in FIG. 1 with the base body fluid channels 21 reaching into the base body 20.

In a first position (which is not shown), the first fluid channels 31 connect and/or bring into communication the base body ports 22 and the base body fluid channels 21 on the right side of the base body 20 in FIG. 1 with the base body fluid channels 21 and base body ports 22 on the left side of the base body 20. When the sleeve 30a is rotated about the longitudinal axis A, for example by motor, via the flange 33, the second fluid channels 32 connect and/or bring into communication other ones of the base body ports 22 and the base body fluid channels 21 on the right side of the base body 20 in FIG. 1 with other ones of the base body fluid channels 21 and base body ports 22 on the left side of the base body 20.

Assuming, for example, that multiple extruders are connected to the base body ports 22 on the right side of the base body 20 in FIG. 1, via the first and second fluid channels 31 and 32 (groups of fluid channels) of the sleeve, the fluid and/or material flows of these extruders may be conveyed to any of the base body ports 22 on the left side of the base body 20. The arrangement of the first and second fluid channels 31 and 32 on the sleeve 30a determines the path the fluid and/or material flow takes from the extruders through the base body 20 and the sleeve 30a. In the exemplary embodiment shown in FIGS. 1 and 2, the fluid and/or material flows in the distribution block 10 are changed by rotation of the sleeve 30a from the first position, in which the first fluid channels 31 are flown through, into the second position, in which the second fluid channels 32 are flown through.

Of course, further fluid channels and thus further positions may be provided. The fact that in the sectional view of FIG. 1 the sleeve fluid channels 31 and 32 are visible does not mean that the sleeve fluid channels 31 and 32 necessarily simultaneously convey the fluid in one of the positions. In contrast, it is possible that a sleeve fluid channel in the first position establishes a certain connection between two base body ports 22 and in the second position the same sleeve fluid channel establishes another connection between two base body ports 22.

FIG. 3 shows a further exemplary embodiment of the distribution block, wherein again, equal reference numbers and/or component designations are used for equal parts as before in FIGS. 1 and 2. In order to avoid unnecessary repetitions, it is pointed to/reference is made to the detailed description in FIGS. 1 and 2 above.

FIG. 3 discloses a distribution block 10 for extrusion melt. The distribution block 10 comprises a base body 20 into which a sleeve 30b is inserted. In general, the distribution block 10 in FIG. 3 corresponds to the distribution block 10 in FIG. 1, which is why merely differences are addressed. The sleeve 30b protrudes from the base body 20 at the bottom in FIG. 3 and is cylindrical, not conical as in the case of the first exemplary embodiment of FIGS. 1 and 2. The base body 20 of FIG. 3 also comprises base body fluid channels 21 and base body ports 22.

The exemplary embodiment shown in FIGS. 3 and 4 discloses the sleeve 30b with two positions, wherein FIG. 3 shows the first position in which first sleeve fluid channels 31 (group of fluid channels) connect the base body ports 22 and base body fluid channels 21 of the right side of the base body 20 shown in FIG. 3 with those of the left side and thus accordingly convey fluid and/or extrusion melt.

When the sleeve 30b is now to be brought into the second position, the sleeve 30b is displaced parallel to its longitudinal axis A upwards in FIG. 3, such that the second sleeve fluid channels 32 (group of fluid channels) connect and/or bring into communication the base body ports 22 and base body fluid channels 21 of the right side of the base body 20 shown in FIG. 3 with those of the left side and thus accordingly convey fluid and/or extrusion melt differently than in the first position. Optionally, the sleeve 30b may be additionally rotated and thus, for example, two displacement positions and in these displacement positions two twisting positions are obtained, which in this case would mean four different positions. This would be a combination of a variant of the first exemplary embodiment with the cylindrical sleeve and the presently described second exemplary embodiment.

FIGS. 3 and 4 show the sealing sections 34 which seal the sleeve fluid channels 31 and 32 parallel to the longitudinal axis A. In this regard, the sleeve fluid channels 31 and/or 32 are each separated from one another by a pair of sealing sections 34. However, it is also possible for a configuration to be selected in which not two sealing sections 34 are arranged between the sleeve fluid channels 31 and 32 as in FIGS. 3 and 4, but merely one sealing section 34. Moreover, the sleeve 30b also comprises a flange 33 which serves for motorized movement of the sleeve 30b and as a mechanical stop.

It applies to both exemplary embodiments that the sleeve fluid channels may divide a fluid stream coming from one individual base body port and convey it to two or multiple base body ports. Vice versa, a fluid stream coming from two or multiple base body ports may be joined to one base body port by sleeve fluid channels.

The sleeve fluid channels may connect any base body ports upstream of the sleeve to any base body ports downstream of the sleeve. The connection is determined by the individual and random design of the sleeve fluid channels.

The sleeves and/or base bodies may comprise rinsing channels and/or rinsing ports, such that material and/or fluid which is still present in the fluid channels of the distribution block from coextrusion may be rinsed before another coextrusion is performed. This may happen in the first position of the sleeve, in the second position of the sleeve or in a rinsing position of the sleeve.

At least one of the fluid channels, the sleeve or the base body may be heated. Moreover, the fluid channels may be heated to different temperatures separately from one another. Moreover, the fluid channels in the sleeve and/or in the base body may be thermally separated from one another.

FIGS. 1 and 3 show no base body fluid channels 21 on the right side since these happen not to lie in the section plane. However, on the left side of FIGS. 1 and 3, base body fluid channels 21 connect the base body ports 22 with the sleeve fluid channels 31 and/or 32.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

10 Distribution block
20 Base body
21 Base body fluid channel
22 Base body port
30a Sleeve
30b Sleeve
31 First sleeve fluid channel
32 Second sleeve fluid channel
33 Flange
34 Sealing section
A Longitudinal axis

1-14. (canceled)

15: A distribution block (10) for extrusion melt, comprising a base body (20) and at least one sleeve (30a, 30b), wherein the base body and the at least one sleeve (30a, 30b) have communicating fluid channels (21, 31, 32), wherein the at least one sleeve (30a, 30b) is mounted in the base body (20) so as to be movable, wherein the at least one sleeve (30a, 30b) may be positioned in a first position in relation to the base body (20), so as to bring a first group of fluid channels (31) of the at least one sleeve (30a, 30b) in communication with fluid channels (21) of the base body (20), wherein
at least one fluid channel of the first group of fluid channels of the at least one sleeve (30a, 30b) is configured to be operated at a different temperature level than a second fluid channel of the first group of fluid channels (31) of the at least one sleeve (30a, 30b)
and
the fluid channels of a group of fluid channels of the at least one sleeve (30a, 30b) are thermally insulated from one another.

16: The distribution block (10) for extrusion melt according to claim 15, wherein the at least one sleeve (30a, 30b) may be positioned in a second position in relation to the base body (20), so as to bring a second group of fluid channels (32) of the at least one sleeve in communication with the fluid channels (21) of the base body (20).

17: The distribution block (10) for extrusion melt according to claim 15, in which the at least one sleeve (30a; 30b) is mounted in the base body so as to be linearly displaceable along its longitudinal axis and/or rotatable in relation to its longitudinal axis.

18: The distribution block (10) for extrusion melt according to claim 17, in which the at least one sleeve (30a, 30b) is movable by motor.

19: The distribution block (10) for extrusion melt according to claim 15, in which the at least one sleeve (30a, 30b) comprises sealing sections (34).

20: The distribution block (10) for extrusion melt according to claim 15, wherein the fluid channels (21, 31, 32) in the at least one sleeve (30a, 30b) and the base body (20) may be brought into a rinsing position in relation to one another by movement of the sleeve.

21: The distribution block (10) for extrusion melt according to claim 15, in which the at least one sleeve (30a, 30b) protrudes from the base body (20) on both ends.

22: The distribution block (10) for extrusion melt according to claim 15, in which the at least one sleeve (30a) is essentially conical.

23: A method for coextruding films with the aid of a distribution block (10) for extrusion melt, comprising the steps of connecting extruders to the distribution block (10) for extrusion melt, positioning at least one sleeve (30a, 30b) in a first position, such that fluid channels (21) in a base body (20) of the distribution block (10) for extrusion melt communicate with fluid channels (31) in the at least one sleeve (30a, 30b), a first coextrusion, adjusting the at least one sleeve (30a, 30b) to a second position in relation to the base body (20), such that other fluid channels (32) communicate, a second coextrusion, wherein the method comprises controlling of the temperature of at least one of the base body (20), the at least one sleeve (30a, 30b) or the fluid channels (21, 31, 32) in the base body and/or the at least one sleeve (30a, 30b), wherein
the fluid channels of a group of fluid channels of the at least one sleeve (30a, 30b) are thermally insulated from one another
and
controlling the temperature depends on the position of the at least one sleeve (30a, 30b).

24: The method according to claim 23, further comprising rinsing after the first coextrusion and prior to positioning in the second position.
